(19) United States
(12) Patent Application Publication
(10) Pub. No.: US 2025/0062717 A1
(43) Pub. Date: Feb. 20, 2025

(54) System for Mounting Photovoltaic Modules for an Overhead Structure

(71) Applicant: Lumos Solar, Inc., Lafayette, CO (US)

(72) Inventor: Scott Franklin, Nederland, CO (US)

(73) Assignee: Lumos Solar, Inc., Lafayette, CO (US)

(21) Appl. No.: 18/808,671

(22) Filed: Aug. 19, 2024

Related U.S. Application Data
(60) Provisional application No. 63/533,513, filed on Aug. 18, 2023.

(51) Int. Cl. H02S 40/00; E04D 13/04; H02S 20/23

(52) U.S. Cl. CPC H02S 40/00; E04D 13/0445; H02S 20/23

(57) ABSTRACT

A photovoltaic (“PV”) module mounting system including a rail having a base wall and opposed first and second sidewalls extending outwardly therefrom. The first and the second sidewalls each have a flange extending outwardly therefrom. The flanges form a mounting surface adapted to support a PV module. The first and the second sidewalls define therebetween an open channel. A wire support is disposed between the first and second sidewalls and is adapted to support wires extending through the channel at a distance spaced from the base wall. The wire support divides the channel into a wireway and a water channeling portion. The wire support includes an opening therein to permit fluid communication between the wireway and the water channeling portion.

This application claims the benefit of priority to U.S. Provisional Patent Application Ser. No. 63/533,513 filed on Aug. 18, 2023, the entire content of which is incorporated by reference herein for all purposes.

### FIELD OF THE DISCLOSURE

The present disclosure relates to a mounting system for photovoltaic modules for forming an overhead structure and more particularly a mounting system for securing and joining an array of modules using a plurality of mounting rails that support module wiring and direct precipitation away from the array.

### BACKGROUND

Photovoltaic (“PV”) modules, also known as solar modules, are well known in the art for converting solar energy into electrical energy. As the desirability for clean and efficient energy sources increases, so does the desire to use power sources such as PV modules.

PV modules are typically mounted on a structure, such as a roof of a house or building where they are readily exposed to sunlight. PV arrays can also be used to form the roof of the structure, such as parking decks, car ports and canopies. Since the modules are exposed to the environment, they need to be properly secured to the structure so they can withstand winds and other environmental effects. Photovoltaic modules are typically secured to structures by way of elongated rails secured to the structure. It is known to use various clamps and hardware that are securable by a threaded bolt and nut to an elongated rail. The clamps may be positioned to engage and secure the PV modules.

PV modules may be surrounded by a frame that provides some protection to the edges of the panel and provides a means for mounting the modules to a structure. PV mounting systems of the prior art require the securement and adjustment of numerous fastening elements to secure the PV modules. In addition, adjustments as to the position of each module are often required which is time consuming and increases the complexity and cost of installation. In addition, by having the mounting hardware engage the edge of the module, the module edges cannot be placed in close proximity to each other. Such a mounting system also leaves exposed the mounting hardware and rails which negatively affects the aesthetics of an installation.

PV modules that form the cover or roofs of a structure are subjected to the elements including rain and snow. It is desirable to have such precipitation channeled away from the surface to permit the PV modules to perform at maximum efficiency.

Accordingly, it would be desirable to provide a system and method for securing PV modules to a structure in a secure and efficient manner and for channeling away precipitation.

### SUMMARY

The present disclosure provides a photovoltaic (“PV”) module mounting system including a rail having a base wall and opposed first and second sidewalls extending outwardly therefrom. The first and the second sidewalls each have a flange extending outwardly therefrom. The flanges form a mounting surface adapted to support a PV module. The first and the second sidewalls define therebetween an open channel. A wire support is disposed between the first and the second sidewalls and is adapted to support wires extending through the channel at a distance spaced from the base wall. The wire support divides the channel into a wireway and a water channeling portion. The wire support includes an opening therein to permit fluid communication between the wireway and the water channeling portion.

The present disclosure also provides a photovoltaic (“PV”) module mounting system including a first and a second PV module each including a perimeter frame. Each perimeter frame has a first side and a second side opposed from the first side, and each perimeter rail each have a mounting surface adapted to support the first and second PV modules. The first and second rails are disposed in substantially parallel spaced relation to each other and being adapted to be secured to a support structure. The first and second PV modules are secured to the first and second rails adjacent to each other and forming a first gap therebetween, and the fourth side of the first PV module has a first projection extending therefrom. The first projection of the first PV module is disposed above and extends over and covers the first gap.

The present disclosure further provides a covering for an overhead structure including a PV module array including a support structure including a plurality of interconnected support members and a plurality of PV modules each including a perimeter frame. A plurality of rails each have a base wall and an opposed first and second sidewalls extending outwardly therefrom. The first and the second sidewall have a flange extending outwardly therefrom. The flanges form a mounting surface adapted to support one of the PV modules, and the first and second sidewalls define therebetween an open channel. Each of the plurality of rails is disposed on one of the plurality of support members and is aligned parallel to each other. The plurality of PV modules is secured to the plurality of rails wherein a space is formed between the PV modules over the rail channels. The rails and PV modules secured thereto form an uninterrupted cover that prevents precipitation from falling therethrough the cover.

### BRIEF DESCRIPTION OF THE DRAWINGS

FIG. 1 is a perspective view of an overhead structure having a PV module array of the present disclosure.

FIG. 2. is a partial top plan view of the overhead structure of FIG. 1

FIG. 3 is a perspective view of the rail end supporting PV modules and the rail resting on a support structure.

FIG. 4 is a bottom perspective view of a rail supporting PV modules.

FIG. 5 is a top perspective view of a rail.

FIG. 6 is a perspective view of overlapped ends of the PV modules supported on a rail.

FIG. 7 is a partial side elevational view of a PV module.

FIG. 8 is a partial side elevational view showing two adjacent PV modules with overlapped ends.

FIG. 9 is a bottom perspective view showing a PV module joining device.

### DETAILED DESCRIPTION

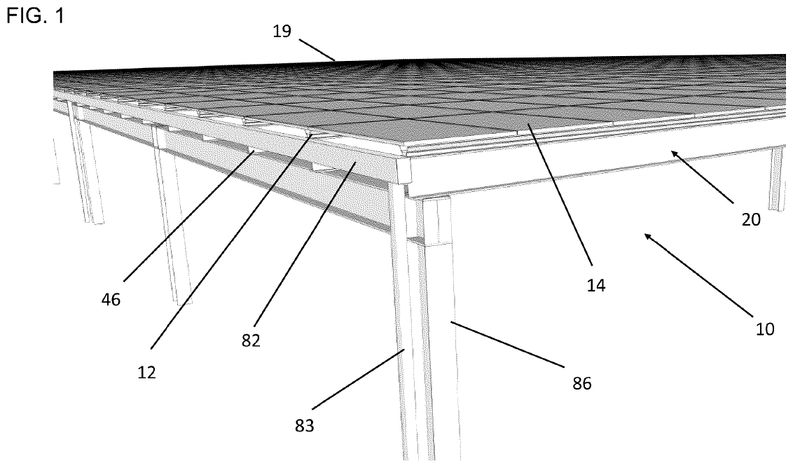

With reference to FIGS. 1-3, a photovoltaic (“PV”) module mounting system 10 including mounting rails 12 for joining together PV modules 14 and in particular PV modules bounded by perimeter frames 16 is shown. The rails 12 join together PV modules to form a PV module array 18. Such arrays can be used to create an uninterrupted covering or roof 19 of a weatherproof overhead structure 20 for such structures as parking decks, carports, canopies, etc., that prevents precipitation from falling below the covering.

The structure to which the array is attached can be angled to both capture the rays of the sun most efficiently and to direct precipitation of the array down off its surface. This permits the PV array 18 to form a water-resistant, uninterrupted roof for the overhead structure 20.

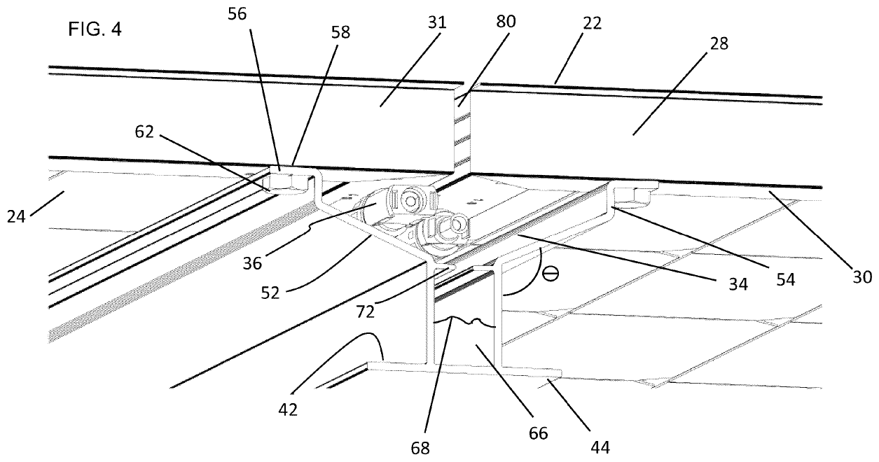

With additional reference to FIG. 4, the PV modules 14 may be of a type known in the art and include photovoltaic panels 22 having an array of solar cells 24 for generating electricity with the PV panel 22 bounded by the perimeter frame 16. The bottom surface of the PV panel may include a junction box (not shown). The frame 16 may include perimeter side walls 28 that extend below the PV panel and have a lip 30 which is used to mount the PV modules 14 to the rails 12 using fasteners 62 as described below.

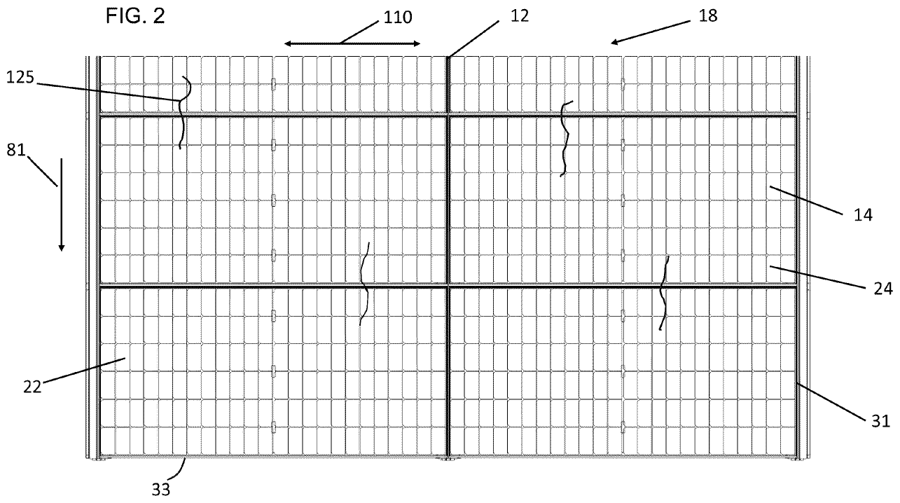

With reference to FIG. 2, the PV modules 14 may have a generally rectangular shape with the perimeter wall including a pair of opposed first frame sidewalls 31 that are parallel to each other and a pair of opposed second sidewalls 33 that are parallel to each other and perpendicular to the first frame sidewalls 31. The PV modules 14 may be secured to the structure such that the first sidewalls run in a direction 81 parallel to the rails 12 and the second opposed sidewalls extend in a transverse direction 110 perpendicular to the rails 12. As used herein, transverse refers to a direction transverse to or generally perpendicular to the incline direction.

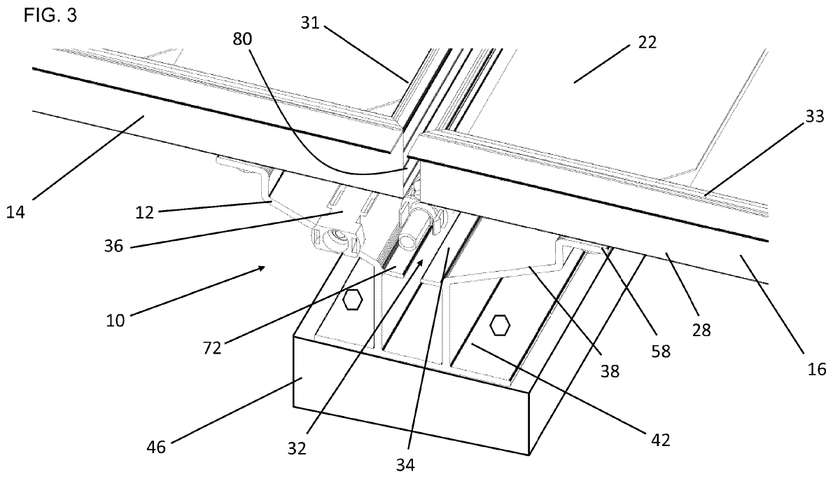

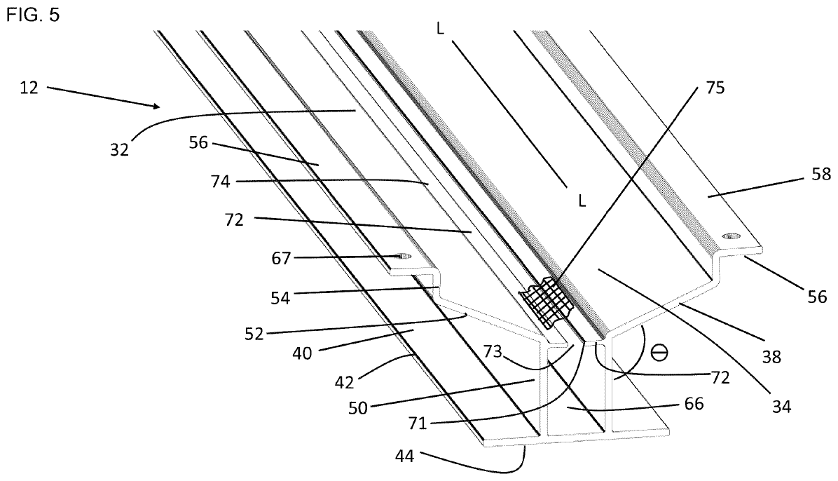

With reference to FIGS. 3-5, the mounting system 10 may include a plurality of similarly formed elongate rails 12 preferably formed of a rigid material, for example, extruded aluminum. It is desirable for the rails 12 to be formed of a conductive material so that it can be used to help ground the PV module array. With further reference to FIGS. 4 and 5, each rail 12 defines an open channel 32 that runs along the length L-L thereof. The channel 32 forms a wireway 34 through which electric wiring 36 associated with the PV modules may run. As shown in FIG. 5, each rail 12 has a generally Y-shaped profile with two opposed, spaced sidewalls 38 extending from a top surface 40 of a base wall 42. The base wall bottom surface 44 is a generally planar surface. Surface 44 is adapted to sit upon a support element 46, such as a beam, which forms the covering or roof 19 of the overhead structures 20, as shown in FIGS. 1-2.

With specific reference to FIG. 5, rail 12 includes opposed sidewalls 38 that are similarly formed and are mirror images of each other. Each sidewall 38 has a bottom first portion 50 that extends generally orthogonally upwardly from a base wall 42. A second portion 52 extends from the top of the first portion 50 upwardly and outwardly such that it forms an obtuse angle Q with the first portion 50. A third portion 54 extends upwardly from the second portion 52 in a direction parallel to the first portion 50. A fourth portion 56 extends upwardly from the third portion and forms a planar mounting surface 58 upon which a PV module frame 14 may rest and be secured thereto by fasteners 62 extending through mounting holes 67 formed on the mounting surface. The fasteners being secured to the lips 30 of the frame 16.

The opposed sidewalls 38 form therebetween the open channel 32 having a bottom section which forms a water channeling gutter 66 that permits water 68 to be channeled away from the PV module array. As the channel 32 extends upwardly from the base wall 42, it widens to form the wireway 34 which is vertically spaced from the base wall 42.

The rail 12 may include a wire support for supporting the wires above the base wall 42. The geometry of the inner surface of opposed sidewalls each form a ledge 72 adapted to support electric wires 36 extending through the channel 32 at a distance spaced from the base wall 42. In one embodiment, the wire support may include a pair of opposed ledges 72 that extends from the first portions 50 adjacent the junction between the first portion and second portion 52. The ledges 72 extend toward each other and have opposed ends 71 that define space 73 therebetween longitudinally extending along the entire length of the rail 12. The ledges 72 extend along the entire length of the rail 12. In one embodiment, the space 73 has a width such that it is wide enough to permit water to flow therethrough but narrow enough to prevent the wires to fall into the gutter. Therefore, the ledges 72 alone form the wire support surface 74 that supports the wires 36 above the bottom of the channel, or gutter 66, so that they do not sit in water and become susceptible to corrosions or otherwise be compromised by the elements.

In one embodiment, the space 73 between the opposed ledges 72 may be spanned by an electric wire support surface 74 extending along the length of the rail 12. The wire support surface 74 may be formed of a material that permits water to pass therethrough. For example, the material may be a mesh material 75 that is sufficiently rigid to support wires 36 running there along and including openings 76 therein to permit water to pass through the surface 74. The mesh 75 supports the wires above the bottom of the channel, or gutter, so that they do not sit in water and become susceptible to corrosions or otherwise be compromised by the elements. It is contemplated that the wire support 74 may extend over only a portion of the length of the rail. The wire support surface 74 may also include a plurality of separate supports, either solid or porous, that are spaced along the rail 12 to both support the wires 36 and permit water to flow into the rail gutter 66. In a further alternative embodiment, a plate (not shown) may extend between the two sidewalls and have one or more openings therein to allow water to pass therethrough. The plate may be formed with the rail 12 as part of an extrusion, or it may be a separate element supported between the sidewalls 38.

As shown in FIGS. 1 and 2, the rails 12 are secured on top of overhead structure 20 in a spaced parallel orientation and supported at an incline such as in a typical roof. The support structure may be beams 46 for the roof or covering of the overhead structure. The beams for the covering may be secured to vertical columns or posts 86. A PV module 14 extends over two adjacent inclined rails and is secured thereto. In one embodiment, the rail mounting surfaces may include mounting holes 67 as shown in FIGS. 4 and 5. The PV panels frame lip has openings for receiving a fastener 62. An installer aligns the frame openings with the rail mounting holes and uses a fastener to secure the panel to the rails. One PV module is joined to one rail mounting surface and the other PV module 14 is mounted to the other rail mounting surface as shown in FIGS. 3 and 4. When both PV modules 14 are secure to the rail a gap 80 is formed between the PV modules over the channel 32 as shown in FIGS. 3 and 4. This provides a way for precipitation 125, such as rain or melted snow, to run off the cover 19 in the direction of incline 81 and into the channel 32. The water will then fall into the rail gutter 66 and then flow down the incline into a perimeter gutter 82 disposed on a perimeter of the PV module array as shown in FIG. 1 and then down through a downspout 83 and away from the structure 20.

The wiring attached to the PV modules 14 is directed through the wireway, and electrical connections to connect the PV panels to a power distribution system may be made in a manner well known in the art. A plurality of rows of rails 12 may be assembled substantially parallel to each other to accommodate an array of PV modules 14 as shown in FIG. 1.

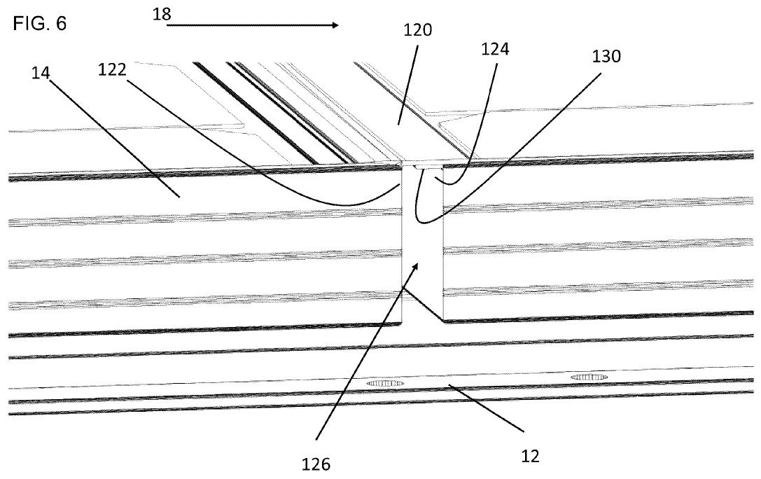

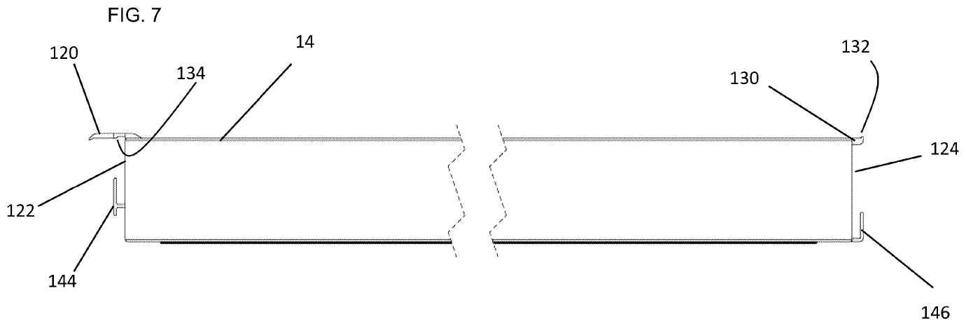

With reference to FIGS. 2 and 6-8, the gap 80 between the PV modules 14 first sidewall lies over the rail 12 and precipitation or water 125 falling into that gap 80 is directed away along the rail as set forth above. Where the PV modules 14 are assembled into an array, a gap 126 also exists between the PV modules second sidewalls 33, which run generally perpendicular to the direction of incline. Accordingly, the PV modules 14 include a structure to cover the gap 126 and to help to shed precipitation 125 off the array 18 and keep the area below the structure dry.

When the PV modules 14 are secured to the rails 12 the gap 126 is formed between the sidewall edges 33 of adjacent PV modules running transverse 110 to the direction of incline 81. When the rails are supported on an incline, such as a typical roof, one PV module is disposed above an adjacent PV module relative to the incline. This gap 126 may be covered by a first projection 120 extending from a first transverse perimeter edge 122 of the PV module disposed above the other. The first projection 120 extends along the entire length of the first transverse perimeter edge 122 of the PV modules. When the PV modules are assembled in an array, the first projection 120 extends over a second transverse edge 124 of an adjacent PV module. The first projection 120 bridges the gap 126 between adjacent modules and prevents precipitation 125 from entering between the PV modules 14. The precipitation 125 will flow down the array off one PV module and onto another PV module until the water eventually falls off the cover 19 and thus will not fall between the array of PV modules 14 and below the cover 19, which they form.

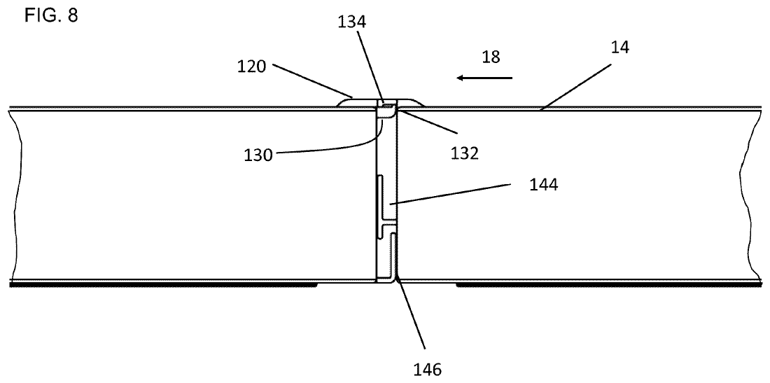

In addition, the adjacent PV module includes a second projection 130 extending outwardly therefrom and along the length of the second edge. The second projection 130 is disposed under the projection 120 of the adjacent PV module. The second projection 130 may have an upturned end 132 that sits within a groove 134 formed on the under surface of the first projection as shown in FIG. 8.

Accordingly, each PV module 14 has a first transverse edge 122 that includes a first projection 120, and a second transverse edge 124 that includes the second projection 130. When the PV modules are installed on an incline the second projection is positioned upstream of the first projection. When the PV modules 14 are installed in an inclined orientation, the PV module is installed with its edge 122 having the first projection 120 downstream, or above, of the edge 124. When the PV modules 14 are assemble in an array, the PV modules 14 are orientated such that the projection 120 is disposed upstream of the edge 124, creating a shingled overlap between the transverse edges of PV modules 14. In this way, precipitation 125 flowing over the array will flow downstream from one PV module to the next until it enters an edge gutter 82 (FIG. 1). Thus, the area below the PV array 18 remains dry and protected from the precipitation.

In addition, as shown FIGS. 4, 7 and 8, the first and second transverse side edges 122 and 124 which are disposed adjacent to each other have generally L-shaped structures respectively, extending therefrom. They each form an open conduit or trough 144 and 146 extending along the length of the side edges, 122 and 124. The conduit 144 on the first edge is disposed above the conduit 146 extending from the second edge as shown in FIG. 8. These vertically offset and horizontally aligned conduits 144 and 146 will catch any water that may get past the overlapping projections and direct the water into the rail gutter 66 where the water 68 can be directed away from the structure 20.

The frame edge having the second projection 130 is positioned upstream of the edge having the first projection 120. The second protection 130 is configured to tuck under the first projection 120 of an adjacent PV module as shown in FIG. 8. While both ends of a PV module may include a first and second projection 120, 130, it is contemplated that in one embodiment only one protection is used to extend over and to completely cover the transverse gap 80 between adjacent PV modules.

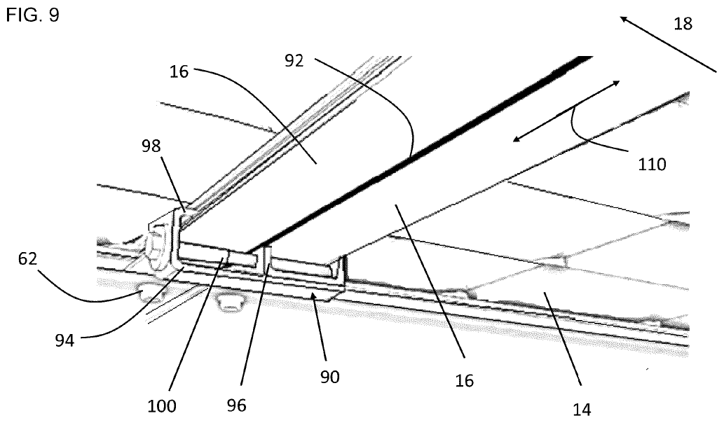

In an alternative embodiment, with reference to FIG. 9, PV modules 14 secured to the rails 12 may be joined to each other by one or more module joining devices 90. In one embodiment, the joining devices 90 may be clamps that engage adjacent PV module frames and urge the adjacent frame walls together. A seal 92 in the form of a strip of resilient material is placed between the adjacent PV module frames 16. The joined module transverse edges of the PV module frames 16 run in a direction 110 transverse to the direction of incline 81 and perpendicular to the direction of the rails 12. The clamp 90 may be a C-shaped member having a first and second element 94 and 96 slidable relative to each other. The first and second elements 94 and 96 each have opposed upper end 98 extending toward each other. The first and second elements 94 and 96 are drawn together upon operation of a threaded fastener 100. The clamp 90 is placed over the frames of adjacent PV modules. The fastener 100 is then tightened such that the first and second elements 94 and 96 move toward each other and engage the frames 16 urging them together. It is within the contemplation of the present disclosure that other clamping devices or securement elements of a type known in the art could be used to secure the adjacent PV module frames together.

When the PV modules 14 are joined by the clamps 90, the seal 92 forms a watertight inter-panel connection such that precipitation falling on the PV modules flows over the PV modules over the edge of the array into the perimeter gutter 82 or into the rail channels 32 and then into the rail gutter 66. Water in rail gutters 66 can be directed to the perimeter gutter 82 (FIG. 1.) and then to a downspout or leader 83 so the water can be channeled away from the overhead structure 20. The joined array of PV modules 14, therefore, form an uninterrupted cover surface that prevents precipitation falling below the cover formed by the array 18. It is further contemplated that, the seal 92, may be used by itself or in combination with the projections 120 and 130 to prevent precipitation 125 from falling below the cover 19.

It will be appreciated that various forms of the above-disclosed features and functions, or alternatives thereof, may be desirably combined into many other different apparatus and systems. It will also be appreciated that various presently unforeseen or unanticipated alternatives, modifications, variations, or improvements therein may be subsequently made by those skilled in the art that are also intended to be encompassed by the disclosed embodiments and the following claims.

What is claimed is:

1. A photovoltaic (“PV”) module mounting system comprising:
a rail having a base wall and opposed first and second sidewalls extending outwardly therefrom, the first and the second sidewalls each having a flange extending outwardly therefrom, the flanges forming a mounting surface adapted to support a PV module; and
the first and second sidewalls define therebetween an open channel, a wire support being disposed between the first and the second sidewalls adapted to support wires extending through the channel at a distance spaced from the base wall, the wire support dividing the channel into a wireway and a water channeling portion, the wire support including an opening therein to permit fluid communication between the wireway and the water channeling portion.

2. The mounting system as defined in claim 1, wherein the wire support divides the channel into a wireway adapted to permit wiring to extend therethrough and a gutter adapted to channel water wherein the wireway is disposed above the gutter.

3. The mounting system as defined in claim 1, wherein the wire support includes a first support ledge projecting from the first sidewall and a second support ledge projecting from the second sidewall and the first support ledge, the first and second ledges defining the opening.

4. The mounting system as defined in claim 1, wherein the opening is a slot formed by the ends of the first and second ledges that extends along the length of the rail.

5. The mounting system as defined in claim 2, wherein the support ledges include a wire support disposed thereon, the wire support including a plurality of openings.

6. The mounting system as defined in claim 1, wherein the flanges lie in the same plane to form a planar mounting surface, and the planar mounting surface including a plurality of mounting holes formed therein.

7. The mounting system as defined in claim 2, wherein the wireway is wider than the gutter.

8. The mounting system as defined in claim 1, wherein the base wall extends beyond the first and second sidewalls and the base wall form a planar surface adapted to be secured to a support structure.

9. A photovoltaic (“PV”) module mounting system comprising:
a first and a second PV module each including a perimeter frame, each perimeter frame having a first side and a second side opposed from the first side, and each perimeter frame having a third side and a fourth side opposed from the third side;
a first rail and a second rail each having a mounting surface adapted to support the first and second PV modules, the first and second rails being disposed in substantially parallel spaced relation to each other and being adapted to be secured to a support structure; and
the first and second PV modules being secured to the first and second rails adjacent to each other and forming a first gap therebetween, and the fourth side of the first PV module has a first projection extending therefrom, wherein the first projection of the first PV module is disposed above and extends over and covers the first gap.

10. The mounting system as defined in claim 9, wherein the third side of second PV module has a second projection extending therefrom, wherein the first projection of the first PV module is disposed above and extends over the second projection of the second PV module.

11. The mounting system as defined in claim 10, wherein the first and second rails are secured to a support structure on an incline and the first PV module is disposed above the second PV module.

12. The mounting system as defined in claim 10, further including a third PV module having a perimeter frame, the perimeter frame having a first side and a second side opposed therefrom, and having a third side and a fourth side opposed from the third side, and the first side of the third PV module is secured to the first rail and the second side of the third PV module is secured to the second rail, wherein the third PV module is disposed adjacent to the second PV module forming a second gap therebetween, and the fourth side of the second PV module has a first projection extending therefrom which is disposed above and extends over and covers the second gap.

13. The mounting system as defined in claim 12, wherein the third side of the third PV module has a second projection extending therefrom wherein the first projection of the second PV module is disposed above and extends over the second projection of the third PV module.

14. The mounting system as defined in claim 10, wherein the second projection has an upper surface having a groove extending along a length thereof.

15. The mounting system as defined in claim 9, wherein the first and second rails each have a base wall and opposed first and second sidewalls extending outwardly therefrom, the first and second sidewall each having a flange extending outwardly therefrom, the flanges forming the mounting surface for supporting the first and second PV modules.

16. The mounting system as defined in claim 15, wherein the first and second sidewalls of the first and second rails define therebetween an open channel, and a wire support extends between the first and second sidewalls and is adapted to support wires operably connected to at least one of the first, the second or the third PV modules and extending through the open channel, and wherein the wire support is spaced a distance from the base wall.

17. The mounting system as defined in claim 16, wherein the wire support includes a first support ledge projecting from the first sidewall and a second support ledge projecting from the second sidewall, the first and the second ledges extending toward each other into the channel and forming a slot therebetween extending along the length of the rail.

18. A covering for an overhead structure including a PV module array comprising:
a support structure including a plurality of interconnected support members;
a plurality of PV modules each including a perimeter frame;
a plurality of rails each having a base wall and opposed first and second sidewalls extending outwardly therefrom, the first and the second sidewall having a flange extending outwardly therefrom, the flanges forming a mounting surface adapted to support one of the PV modules, and the first and second sidewalls defining therebetween an open channel; and
each of the plurality of rails being disposed on one of the plurality of support members and being aligned parallel to each other, the plurality of PV modules being secured to the plurality of rails wherein a space is formed between the PV modules over the rail channels, and wherein the rails and PV modules secured thereto form an uninterrupted cover that prevents precipitation from falling therethrough the cover.

19. The covering as defined in claim 18, wherein at least one of the plurality of rails includes a wire support disposed in the channel and spaced a distance from the base wall.

20. The covering as defined in claim 19, wherein the wire support includes a pair of opposed ledges extending toward each other and forming a surface for supporting wire operably connected to at least one of the plurality of PV modules.

21. The covering as defined in claim 18, wherein the plurality of PV modules includes a first PV module and a second PV module, the first PV module has a perimeter including a first edge extending in a direction perpendicular to the rails, the first edge having a projection extending therefrom, the projection extending over a gap formed between the first PV module and the second PV module.

22. The covering as defined in claim 18, wherein the plurality of rails is supported on an incline and the plurality of PV modules are spaced from each other with a first PV module being disposed above a second PV module relative to the incline, and the first PV module has a first projection extending over and covering a space between the first and second PV modules.

23. The covering as defined in claim 22, wherein the second PV module has a second projection extending therefrom and disposed below the first projection.
